(19) United States
(12) Patent Application Publication
(10) Pub. No.: US 2008/0018787 A1
(43) Pub. Date: Jan. 24, 2008

(54) Method and Apparatus for Producing Images

(76) Inventors: William Robb Hopper, Victoria (AU); Jack Chandler, Victoria (AU)

Correspondence Address: MICHAEL BEST & FRIEDRICH LLP, 100 E WISCONSIN AVENUE, Suite 3300, MILWAUKEE, WI, 53202, US

(21) Appl. No.: 10/594,865

(22) PCT Filed: Apr. 1, 2005
(86) PCT No.: PCT/AU05/00478

§ 371 Date: Jul. 5, 2007

(30) Foreign Application Priority Data
Apr. 1, 2004 (AU) 2004901752

(51) Int. Cl. H04N 5/14; H04N 7/01

(52) U.S. Cl. 348/448; 348/207.99

(57) ABSTRACT

A method and apparatus for processing an image for storage or transmission, the method comprising dividing an image in the form of image data into three or more image data subsets, and sequentially outputting the image data subsets as fields in or as a television signal. The method may include capturing the image, and the method may include forming the subsets so as to be interlaceable.

### RELATED APPLICATION

This application is based on and claims the benefit of the filing date of AU application no. 2004901752 filed 1 Apr. 2004, the contents of which are incorporated herein by reference in its entirety.

### FIELD OF THE INVENTION

The present invention relates to a method and apparatus for producing visual images, and is of particular but by not means exclusive application in processing an image for storage or transmission.

### BACKGROUND OF THE INVENTION

The international television video standards in common use today are the NTSC (National Television System Committee), PAL (Phase Alternating Line) and SECAM (Système Electronique Couleur Avec Mémoire) standards. All of the these television video standards include the composition of images by the same fundamental approach: each image is composed of horizontal lines scanned across the image plane. These scan lines form a set of nearly horizontal image stripes—referred to as lines—that form the actual image, with a single image comprising two consecutive sets of interlaced or interleaved lines.

That is, a first (approximately) half of the scan lines are configured to occupy only every second line of the full image and the remaining or second half of the scan lines occupy the intermediate positions. The two half sets are thus interlaced to form the actual image. Such a complete interlaced image is referred to as an “image frame” and comprises an “odd image field” and an “even image field”.

The number of scan lines defined for each of these international standards differs. NTSC defines 525 lines at a scan rate of 30 frames (60 fields) per second; PAL and SECAM define 625 scan lines at a scan rate of 25 (50 fields) frames per second. The signal is constructed so that the scan lines are interlaced. The interlaced signal is a raster scan pattern where each second line scans for a full display height first and then the interlaced lines between these are scanned as the even image field. Thus, in NTSC lines 1 to 265 (the odd field) are scanned, followed by—interlaced—lines 266 to 525 (the even field). In PAL and SECAM, lines 1 to 313 (the odd field) are scanned, followed by—interlaced—lines 314 to 625 (the even field).

A video sequence is collected as a series of image frames, each acquired in turn by means of an image sensor, and transmitted as a sequence of pairs of odd and even fields. FIG. 1 is a schematic representation of the resulting sequence of odd and even fields in a standard television image. The sequence is then displayed (such as on a television) as alternate odd and even fields, as depicted schematically in FIG. 2 in the interlaced manner described above. Video signals that conform to these international standard methods of transmission thus comprise a plurality of image frames each of which is composed of two fields; such video signals thus constitute standard television video signals.

One specific example of such a standard television signal is “composite” video, which incorporates the image fields and line synchronisation information within a singe (hence, “composite”) signal. A wide range of equipment, including displays and digital video recorders, are available for use with composite video. Composite video can be provided in PAL, NTSC or SECAM format. Further, composite video can be black and white or full colour. Many digital video cameras, such as those used in CCTV (closed circuit television) security applications, capture video information using a CCD (charge coupled device) or similar image sensor array and then output the video images in an analogue composite video format.

This approach provides a good representation of motion video, owing partly to optical persistence in the display device and partly to the nature of human visual perception (as the image is constantly being updated with new image fields that provide progressively updated information about movement in the image scene to the human eye).

However, this approach to constructing an image provides poor resolution still images when, for example, a full frame is frozen or printed. Each image field is captured, in PAL, approximately 20 ms apart (i.e. with a sample rate of 50 Hz) or, in NTSC, 16.7 ms apart (i.e. with a sample rate of 60 Hz), so combining the fields will cause smudging or fuzziness on any moving part of the image. In such cases, any movement that occurs in the field of view between the capturing by the image sensor of the odd field and the capturing of the even field with cause blurring of a still taken from the video, such as in the form of a freeze-frame or printed image. In some applications, such as industrial video security and digital video recorders, the ability to output high quality still images for further analysis, recognition, printing, documentation and use in evidence is important. The international video standards are well established and widely used with large existing infrastructure in cables, transmission methods, video switches, displays and video recorders including digital video recorders, so a umber of attempts have been made to retain these standards while still providing still images of acceptable quality.

Thus, one existing technique for avoiding motion blurring entails displaying the image from only one field (odd or even); this reduces or avoids motion blurring but at the cost of reduced image resolution. In some applications this approach constitutes the use of a “2CIF” image rather than the full “4CIF” image. (The full image frame image is in some applications referred to as a 4CIF image when a resolution of 704×576 pixels is employed, this being four times the number of pixels in a CIF (Common Intermediate Format) image of 352×288 pixels.)

Indeed, most digital video recorders presently record only odd frames or even frames; this technique is, as a result, referred to as 2CIF mode recording.

Another existing technique employs de-interlacing filtering, typically embodied as software, but it is only partially effective and reduces the available resolution.

It is an object of the present invention to provide a method of capturing or transmitting video signals in signal formats such as international standards NTSC, PAL or SECAM that allows the rendering of still images (such as for display or printing) with reduced motion blurring or the like.

### SUMMARY OF THE INVENTION

Thus, according to a first broad aspect of the invention, there is provided a method for processing an image for storage or transmission, comprising:
dividing an image in the form of image data into three or more image data subsets; and
sequentially outputting the image data subsets as fields in or as a television signal.

In one embodiment, the method includes receiving or capturing the image. It will be appreciated that, in this embodiment, the television signal may include conventional image frames (in, for example, NTSC, PAL or SECAM format) as well as the fields comprising the image data subsets. It will also be appreciated that the image data may be converted from one form or format to another between being captured and divided or output (such as from analogue to digital, or from one digital form to another), but that reference to “image data” embraces such data irrespective of any such conversions or transformations. It will also be understood that capturing the image data may comprise the original capturing of the data (such as by videoing a live scene with a video camera), or capturing previously collected video data for use according to this method (such as from a database of existing data in video format).

In one embodiment, the method includes forming the subsets so as to be interlaceable. This allows the image data subsets to be combined to form higher resolution stills. If a plurality of images has been captured, some or all of these images may be output in moving form.

The method thus allows one or more images to be reconstituted from the image data subsets; if desired, still images can be output with the sharpness of the original image data, since—unlike with video data captured in interlaced format by conventional means—these images are converted into interlaced format after being captured.

In one embodiment, the method includes dividing a plurality of images into respective sets of three or more image data subsets, and sequentially outputting the sets of image data subsets as fields in a television signal. The method may include forming each of the sets of image data subsets so as to be interlaceable.

In another embodiment, the method includes outputting the image data subsets as adjacent fields in an otherwise conventional television signal.

The method may include outputting the image data subsets either as odd fields or as even fields in the television signal. The method may include transmitting the television signal for remote storage or display.

This aspect of the invention also provides a method for processing images for storage or transmission, comprising:
forwarding one or more images as image data to a computer system;
forwarding to the computer system command data for prompting the system to divide the image data corresponding to each of the images into three or more image data subsets; and
receiving from the computer system output comprising the image data subsets.

In a second broad aspect, the invention provides an apparatus for processing images for storage or transmission, comprising:
a data input for receiving or capturing an image as image data;
a processor for dividing the image data into three or more image data subsets; and
an output for outputting the image data subsets in or as a television signal.

In one embodiment, the apparatus includes an image capture mechanism for capturing the image.

In another embodiment, the processor is operable to form the subsets so as to be interlaceable.

The apparatus may be or comprise a camera. In one embodiment, the processor is operable to divide a plurality of images into respective sets of three or more image data subsets, and the output is operable to sequentially output the sets of image data subsets as fields in or as a television signal. The processor may then be operable to form each of the sets of image data subsets so as to be interlaceable.

In another embodiment, the apparatus includes a display for displaying the image, the image data subsets or both the image and the image data subsets.

The processor may be operable to divide the image data into an even number of image data subsets. The apparatus may be operable to transmit the image data subsets for remote display.

In a third broad aspect, the invention provides a video camera, comprising:
an imaging subsystem for capturing one or more images as image data;
a processor for dividing the image data corresponding to each of the images into at least three image data subsets; and
an output subsystem operable to output the image data subsets in or as a television signal.

The processor may be operable to divide the image data corresponding to each of the images so as to be interlaceable.

The output subsystem may be operable to output the image data subsets in or as a television signal in standard NTSC, PAL or SECAM format.

According to a fourth broad aspect, the invention provides a method for inserting at least one image in the form of image data into a television signal, comprising:
dividing the image into a set of image data subsets; and
inserting the set into the television signal with each subset corresponding to a respective field of the television signal and with the set preceded or followed in the television signal by a conventional image frame.

In one particular embodiment, the image is one of a plurality of images each in the form of image data and the method includes:
dividing the image data corresponding to each of the images into a respective set of image data subsets; and
inserting the sets periodically into the television signal with each subset corresponding to a respective field of the television signal and with each of the sets preceded or followed in the television signal by a conventional image frame.

Thus, each set of a plurality of image data subsets appears in the signal, preferably—for each set—with the subsets adjacent to each other. In one embodiment, the groups are separated from one another by an equal number of frames.

According to a fifth broad aspect, the invention provides a method of decoding a television signal, the method comprising:
extracting first image data from the odd image fields of the television signal; and
extracting second image data from the even image fields of the television signal;
wherein one of the first image data and second image data comprises a first set of images that are sequentially displayable as a motion video and the other of the first image data and second image data comprises a second set of images that are assemblable into a further image.

In a particular embodiment, the second set of images are assemblable into a plurality of further images. The plurality of further images may be sequentially displayable as a further motion video; the further motion video may comprise a manipulated version of the motion video derived from the first set of images.

According to a fifth broad aspect, the invention provides a method for processing an image for storage or transmission, comprising:
dividing an image in the form of image data into a plurality of image data subsets; and
sequentially outputting the image data subsets as fields in or as a television signal;
wherein the subsets are both reassemblable by interlacing according to a conventional television standard to form a first image, and otherwise reassemblable to form a second image.

The second image may, superficially, appear similar to the first image, but differ in resolution, colour balance, contrast, etc.

### BRIEF DESCRIPTION OF THE DRAWING

In order that the invention may be more clearly ascertained, embodiments will now be described, by way of example, with reference to the accompanying drawing, in which:

FIG. 1 is a schematic representation of the sequence of odd and even fields in a television image according to the background art;

FIG. 2 is a schematic representation of the sequence of odd and even fields as subsequently displayed in interlaced form according to the background art;

FIG. 3A is a schematic view of a high resolution video camera according to an embodiment of the present invention, shown with a digital video recorder;

FIG. 3B is a schematic view of the camera of FIG. 3A, configured for use with an alternative a digital video recorder;

FIG. 4 is a schematic representation of the decomposition of a high resolution image into a television video signal according to an embodiment of the present invention;

FIG. 5 is a schematic representation of the reassembly of a high resolution image from a television video signal according to an embodiment of the present invention; and

FIG. 6 is a schematic representation of the decomposition of a television video signal into a video signal and the components of a high resolution image according to an embodiment of the present invention.

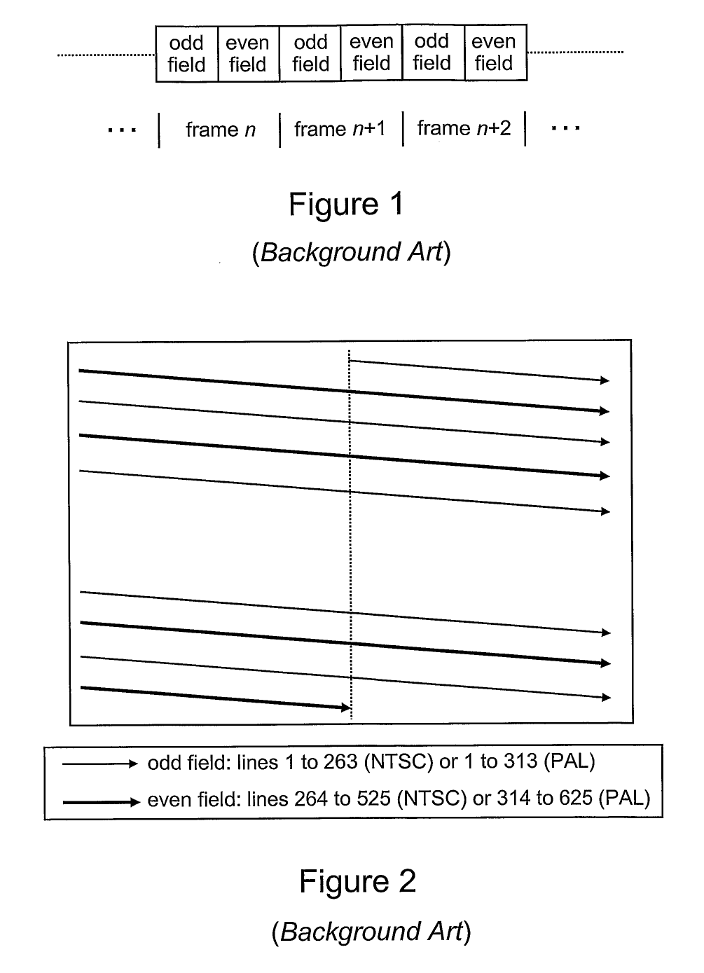

### DETAILED DESCRIPTION OF THE EMBODIMENTS

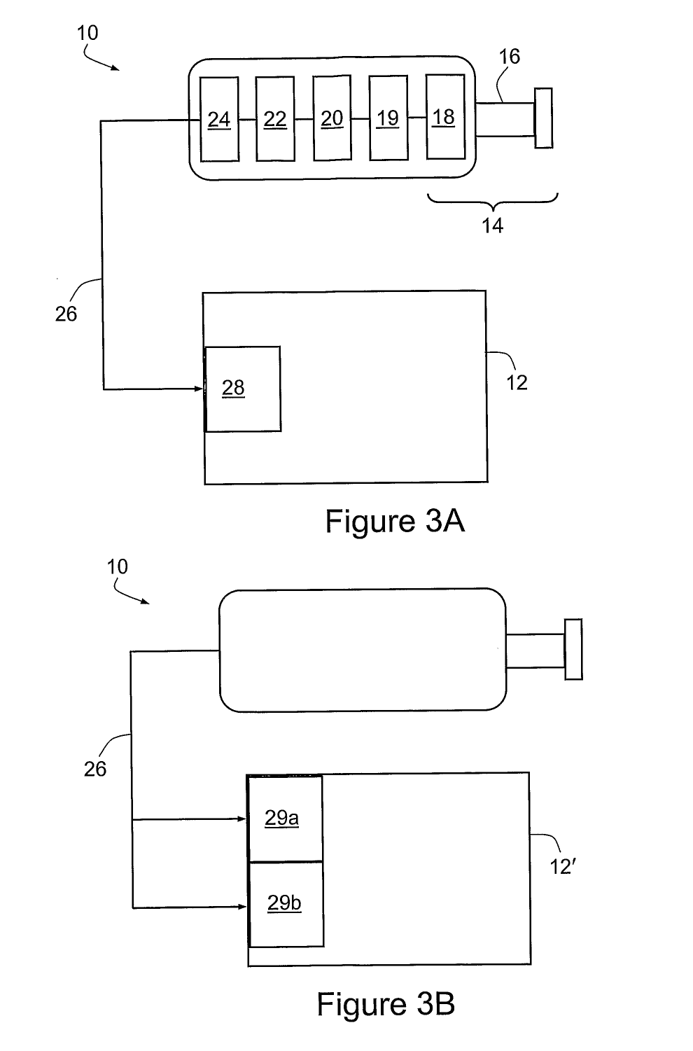

A high resolution video camera according to an embodiment of the present invention is shown schematically at 10 in FIG. 3A, together with—and electronically coupled to—a digital video recorder 12. It will be understood by those in the art that the digital video recorder 12 is—in this figure—provided merely as an exemplary device to which the camera 10 might transmit its output. In other applications, for example, the camera 10 might transmit its output to a video display for immediate display, or to a remote location for storage or display (by cable, wirelessly, via the internet, or otherwise).

The video camera 10 includes an imaging subsystem 14 (including lens assembly 16 and image sensor 18) for capturing high resolution video images as video data, an initial processor 19 for performing some initial image processing (and for controlling the storage of images), local working memory 20 in which video data is stored, a data processor 22 for processing the video data, and an output subsystem or stage 24 for outputting a video signal (in this example, via cable 26 to digital video recorder 12). Such outputting can include performing digital to analogue conversion by essentially conventional techniques. The output signal is typically a composite video signal conforming to the NTSC, PAL or SECAM standard, though other outputs are possible as is described below.

In use, the image sensor 18 is used to capture one or more high resolution images, which are then stored by initial processor 19 in memory 20 (and for subsequent processing—as is described below—by processor 22). An image stored in memory 20 may be updated from the sensor 18 at the full field update rate, with only the resolution required for image fields transferred to the output stage 24 for encoding into a standard motion video signal.

Alternatively, the images can be captured into the memory 20 at a lesser rate so that a high resolution image can be encoded over a set of consecutive image fields.

Thus, the camera 10 is operable to capture non-interlaced video images with a resolution that is greater than the resolution required for a full frame of standard video as a single image. These images are stored in memory 20 so that they can be broken down by processor 20 and output as two fields at the correct timing to form an industry standard television video signal such as PAL, NTSC or SECAM. (It will be noted, however, that the processor 20 may be configured to controllably divide the video data corresponding to each video frame into more than two fields or subsets of video data, and particularly into even numbers of such fields.)

Thus, the processor 20 is operable to divide each image frame into a pair of interlaceable fields suitable for transmission (and recording, display, etc) as standard television image signals. The processor 20 is controllable by means of a control panel (not shown) on camera 10 to process the video data so that the ultimate output comprises pairs of fields that conform to a user-selected one of the NTSC, PAL or SECAM standards. These are passed to output stage 24, which output these fields via cable 26 to digital video recorder 12 as composite video output. Digital video recorder 12 has a digital input for receiving the composite video output.

However, odd and even fields can be treated separately, as they are formed in camera 10 either from different original images or by the decomposition of single images (as is described below). Consequently, when the output of camera 10 is received, the odd and even fields can separated into two separate video output streams. This approach has particular application in systems such as existing 2CIF digital video recorders used in video security applications that already extract only the odd and even frames for analysis or recording or display.

Thus, referring to FIG. 3B, digital video recorder 12′ is comparable to video recorder 12 but has two digital inputs 29a and 29b: first digital input 29a is provided to receive (and record) at 2CIF resolution from odd image fields only, and second digital input 29b is provided to receive (and record) at 2CIF resolution from even image fields only. Video recorder 12′ thus receives (via cable 26) a stream of (odd and even) image fields that it records separately, but which can be combined into a standard television picture. Furthermore, any respective pair of odd and even fields can be combined into a still (for printing or display) that comprises the reconstitution of an original non-interlaced image captured by the camera 10. Consequently, such stills will not suffer from the blurring that occurs when displaying a still formed by combining odd and even fields captured in interlaced fashion (and hence at different times).

The advantage of this latter approach is that the composite video output from the camera 10 is compatible with existing video displays and recorders and will display and replay normally but with increased motion smoothness as individual fields are not supplied as completely new images captured individually for every field. However, when associated image fields are combined and then displayed or printed as a still image, the image will be a high resolution image that is essentially free of interlacing effects and of that motion blurring that is due to interlacing.

This principle can be applied to a single odd and even image field pair to form a image frame from a single image captured at the camera (as described above) or extended to provide very high resolution images from large numbers of image fields combined together. The image fields formed in the camera to be combined later to form a high resolution image would typically comprise a set of odd and even fields in sequence.

This approach thus has the distinct advantage that each pair of odd and even image fields constitutes a complete interlaced image at standard resolution and can be displayed or recorded and transmitted using standard video equipment and techniques such as composite video while still providing the opportunity to combine a number of specific image fields to form a very high resolution image, particularly suited to still image reproduction.

The sets of image fields configured in the camera to be combined to form a high resolution image need not occur continuously in the video signal. For example, the processor 22 may be configured to pass to output stage 24 essentially conventional pairs of odd and even fields for interlacing and display but, periodically (such as twice per second), to insert a high resolution image such as comprising the equivalent of six combined fields into the video stream. For example, in NTSC mode—in which 60 2CIF fields are transmitted per second—the camera 10 could be configured to insert a high resolution image comprising the equivalent of six combined fields into the video stream twice per second and hence after each transmission of 15 pairs of 2CIF fields.

Such variants, and method for using the camera 10, are discussed in greater detail below.

In one example of the use of camera 10, a high resolution image captured, assembled and transmitted as a group of four image fields in an otherwise standard video signal. This technique employs a particular approach for decomposing the image into pixels.

As described above, camera 10 can be used to capture high resolution images. Each image is stored in memory 20. The pixels of each image are—in this example—allocated to four individual image fields by means of processor 22. Each of these four fields is then treated as a standard digital image field for conversion to a standard video signal using the digital to analogue video encoder electronics of output stage 24. These electronics insert each field (and the scan lines that constitute each field) into the output video signal at the correct timing for the signal to conform to NTSC, PAL or SECAM format.

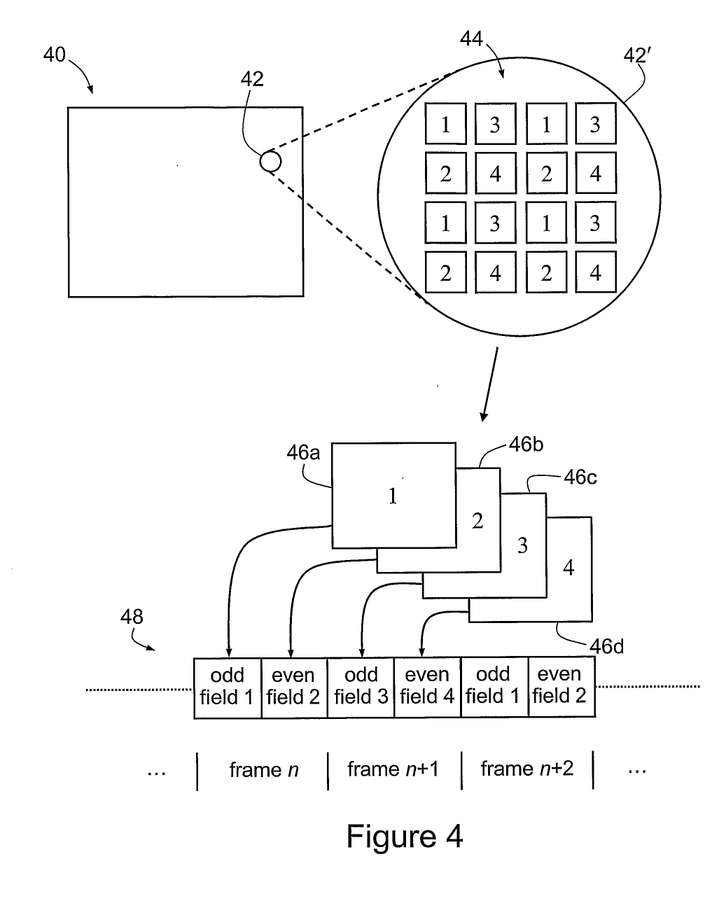

This procedure is illustrated schematically in FIG. 4. FIG. 4 depicts schematically a high resolution image 40 comprising a plurality of individual pixels, captured as a single image by camera 10. This high resolution image 40 is stored in memory 20 and divided into a set of pixels that can be read out of memory 20 and assigned to individual fields.

In this example, the image 40 is split into four fields. Illustrative region 42 of image 40 is shown enlarged at 42′, in which is depicted the individual pixels 44. The pixels are assigned in a regular pattern to four groups; in this example, each second pixel in x and y directions is assigned to one of the four separate fields, and as a result the pixels are equi-spaced both in the original image and in each of the final fields. Other numbers of final fields could be employed and, in some applications, it may not be essential that the pixels allocated to any particular field be equi-spaced in the original image or in the ultimate field.

Thus, in this example, those pixels labelled “1” are assigned to a first field 46a, those labelled “2” are assigned to a second field 46b, those labelled “3” are assigned to a third field 46c and those labelled “4” are assigned to a fourth field 46d. Clearly each of the resulting image fields 46a, 46b, 46c and 46d has a quarter the resolution of the original (high) resolution image 40.

It will be noted that those pixels labelled “1” and those labelled “2” are extracted from adjacent horizontal lines of original image, so image fields 46a and 46b are interlaceable, that is, suitable for interlacing. Similarly, those pixels labelled “3” and those labelled “4” are extracted from adjacent horizontal lines, so image fields 46c and 46d are interlaceable. Image fields 46a, 46b, 46c and 46d are then inserted as consecutive fields in a standard (i.e. NTSC, PAL or SECAM) format video signal 48 by mean of the output stage 24. These standards require two fields per frame, so the first two image fields 46a, 46b (which, as has been noted, are interlaceable) are used for a first frame n, and the second two image fields 46c, 46d (which are also interlaceable) are used for a second frame n+1.

Each subsequent high resolution image is similarly divided into four image fields, and thereby provide subsequent image frames n+2, n+3, etc.

As will be appreciated, the original high resolution image 40 can be decomposed into the (lower resolution) image fields by other suitable techniques; in each case the result are a plurality of lower resolution representation of the original full view of camera 10 such that the ultimate video signal can be replayed as normal motion television video. As the constructed image fields are interlaced on replay, the construction of the fields can be optimised to provide a steady good clarity image as the fields are replayed as moving video.

As the original high resolution image is processed into individual image frames to be issued as a timed sequence in the standard television signal there is a opportunity to provide additional processing of the image and its constituent data pixels. For example, noise reduction, averaging or filtering may be employed by means of processor 22 to further enhance the image quality issued from the camera 10.

Where the image sensor 18 is a CMOS type image sensor, the sensor itself can be employed to act as the image memory and the image fields can be constructed by the processor 22 by reading and processing pixel sets directly from the image sensor 18 to form individual image fields for transfer to the output stage 24 of the camera 10.

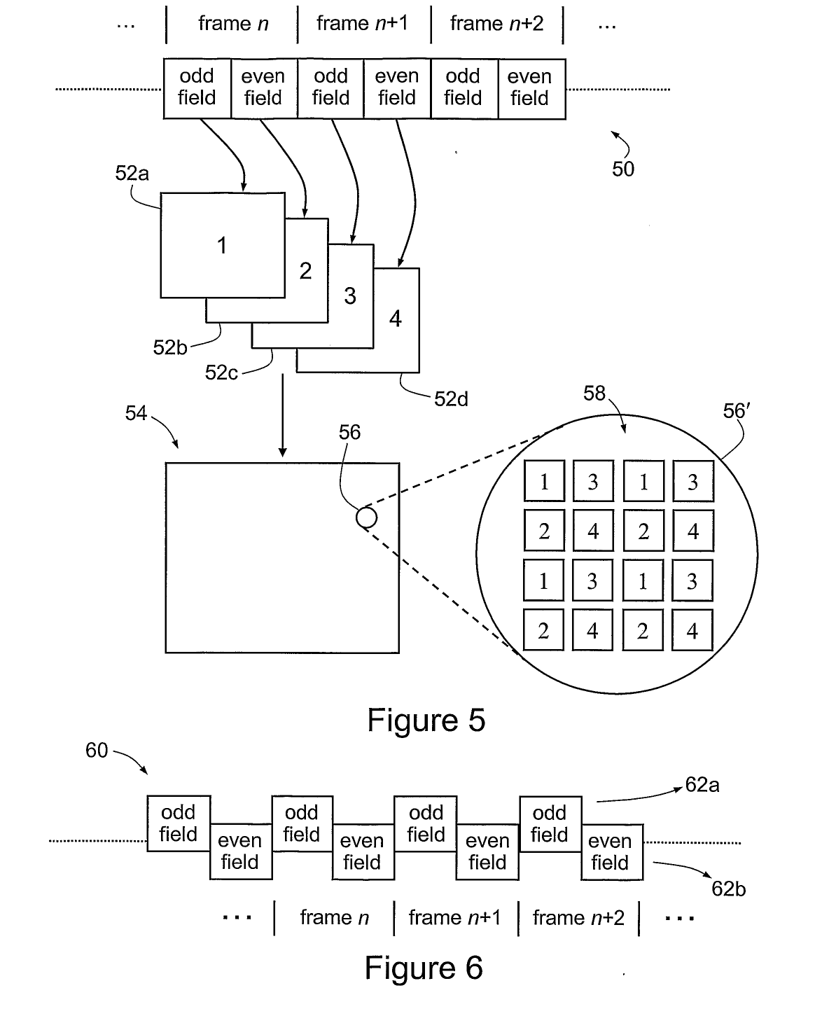

In another example, a high resolution image can be reconstructed from a number of image fields. This procedure essentially reverses that described by reference to FIG. 4, and is illustrated schematically in FIG. 5. Referring to FIG. 5, each frame of a video signal 50 (generated by means of the approach described above) is decomposed into odd and even fields. Each set of four consecutive fields 52a, 62b, 52c, 52d is then combined into a single high resolution image 54. As can be seen from sample region 56 (enlarged at 56′), the pixels 58 of the four fields 52a, 62b, 52c, 52d are in effect interlaced into the form in which the original high resolution image was collected.

The number of image fields that are combined into a single high resolution image generally depends on the resolution available from the image sensor 18. By way of example, a single image field can encode around 400,000 pixels when encoded into standard video using typical industry electronics. On this basis it would be appropriate to encode the output from a 2.2 megapixel image across approximately 8 image fields to deliver an output image over NTSC, PAL or similar that can be recombined into a high resolution image approaching the original image resolution.

In effect this approach trades off overall motion smoothness of the video stream when replayed on standard television or video equipment for significantly increased image resolution when consecutive sets of image fields are combined in other devices such as computer display software or a digital video recorder.

This approach has the advantage that high resolution images can be embedded within a standard NTSC, PAL or SECAM video signal, and transmitted, switched, multiplexed, stored or displayed using existing equipment, cables and infrastructure. The images can be recoded on existing equipment, such as video recording equipment. When a high resolution image is required for analysis, recognition or preparation of a high resolution still image or printout, the individual fields generated from the high resolution image can be recombined in a post processing stage into the original high resolution image. In the case of a digital video recorder, the individual frames are already digitised and saved as digital pixel data for each video field. These fields can then be combined by means of computer software for subsequent display or printing. This feature can be built into the software normally provided with a digital video recorder for searching, replay of video, display of freeze frames and printing still images.

In another example of the use of camera 10, the resolution of the camera can be switched dynamically, that is, the effective image frame rate versus image update rate can be dynamically changed in the camera. For example, camera 10—in NTSC mode—would normally output full motion video at 30 frames per second (i.e. 60 fields per second); every field comprises a new image of normal video resolution, captured sequentially and hence at distinct times. However, in addition the camera 10 is operable to intermittently insert a series of image fields generated from a high resolution original image, so that—if desired—those fields can be recombined in subsequent processing to form a high resolution image. The replay software used to combine the image fields identifies sets of fields intended to be combined by analysis of the image data or by reference to identifying markers or frame group numbers inserted into the image signal. In a standard television video signal (such as a NTSC, PAL or SECAM signal), some of the scan lines encoded in each image frame do not form a part of the image to be displayed. These invisible lines are used for other purposes, such as vertical sync equalization and encoding of text information for subtitles. The same technique by which digital information is encoded in unused image lines for subtitles can be used to encode data for the replay software to identify groups of image fields intended to be combined as a high resolution image.

Camera 10 is operable to dynamically insert high resolution images into the video signal in response to a specific event, which is used to trigger the capture of a high resolution image and the insertion of that image into the video signal as a set of related image fields. Such an event can comprise: an external command to the camera from a data interface or digital input; an alarm trigger on a digital input to the camera; and the output of image processing within the camera.

Other events can arise from the analysis of low (i.e. normal video) resolution images, and indicate that a higher resolution image should be captured. Such events can include: the detection of movement in the field of view of the camera; the detection of a person or face within the field of view; the detection of text or numbers within the field of view; and the detection of a vehicle number plate within the field of view.

In another example of the use of camera 10 (in the configuration of FIG. 3B), odd field images can be derived from lower resolution images updated for every odd field. Referring to FIG. 6, the odd fields in a television signal 60 are used to form a 2CIF image stream 62a of motion video at standard resolution. Every odd field is an image captured at a single frame frequency. The even fields are constructed in the camera 10 to be suitable for transmission 62b to a post-processing system for combining into high resolution images. For example, each group of either consecutive even image fields may be combined into a single high resolution image.

Video signal 60 thus performs as though it is a standard video signal for a conventional system such as a 2CIF digital video recorder that only employs odd image fields. The camera 10 is then able to capture high resolution images less frequently, yet still also provide high resolution images embedded in the even image fields. Indeed, the images encoded on the odd and even fields can be from different image sources, such as separate image sensors housed within camera 10. It is envisaged, however, that camera 10 would include a single high resolution image sensor and provide regular lower resolution images for use, for example, as odd image fields and less frequent high resolution images (suitably decomposed) for use as even fields in the finally encoded video signal.

This approach also allows camera 10 to incorporate a software pan zoom tilt feature. The camera can be constructed to capture high resolution images at the full field update rate. One image stream is then encoded onto the odd fields as a video stream with the full field of view of the camera. The second one image stream is constructed from the working video memory in the camera to provide an image of only a subset of the field of view of the camera. The subset view may be controlled by commands or data supplied to the camera to provide a form of image pan, tilt or zoom by means of the camera software and without movement of the camera. The camera can then alter the image resolution dynamically for either image stream to provide the best balance of image update rate and image resolution for the specific application.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. A method for processing an image for storage or transmission, comprising:
dividing an image in the form of image data into three or more image data subsets; and
sequentially outputting said image data subsets as fields in or as a television signal.

2. A method as claimed in claim 1, including receiving or capturing said image.

3. A method as claimed in claim 1, including forming said subsets so as to be interlaceable.

4. A method as claimed in claim 1, including dividing a plurality of images into respective sets of three or more image data subsets, and sequentially outputting said sets of image data subsets as fields in a television signal.

5. A method as claimed in claim 4, including forming each of said sets of image data subsets so as to be interlaceable.

6. A method as claimed in claim 1, including outputting said image data subsets as adjacent fields in an otherwise conventional television signal.

7. A method as claimed in claim 1, including outputting said image data subsets either as odd fields or as even fields in said television signal.

8. A method as claimed in claim 1, including transmitting the television signal for remote storage or display.

9. A method for processing images for storage or transmission, comprising:
forwarding one or more images as image data to a computer system;
forwarding to said computer system command data for prompting said system to divide the image data corresponding to each of said images into three or more image data subsets; and
receiving from said computer system output comprising said image data subsets.

10. An apparatus for processing images for storage or transmission, comprising:
a data input for receiving or capturing an image as image data;
a processor for dividing said image data into three or more image data subsets; and
an output for outputting said image data subsets in or as a television signal.

11. An apparatus as claimed in claim 10, including an image capture mechanism for capturing said image.

12. An apparatus as claimed in claim 10, wherein said apparatus is or comprises a camera.

13. An apparatus as claimed in claim 10, wherein said processor is operable to form said subsets so as to be interlaceable.

14. An apparatus as claimed in claim 10, wherein said processor is operable to divide a plurality of images into respective sets of three or more image data subsets, and said output is operable to sequentially output said sets of image data subsets as fields in or as a television signal.

15. An apparatus as claimed in claim 14, wherein said processor is operable to form each of said sets of image data subsets so as to be interlaceable.

16. An apparatus as claimed in claim 10, including a display for displaying said image, said image data subsets or both said image and said image data subsets.

17. An apparatus as claimed in claim 10, wherein the processor is operable to divide said image data into an even number of image data subsets.

18. An apparatus as claimed in claim 10, wherein the apparatus is operable to transmit said image data subsets for remote display.

19. A video camera, comprising:
an imaging subsystem for capturing one or more images as image data;
a processor for dividing the image data corresponding to each of said images into at least three image data subsets; and
an output subsystem operable to output said image data subsets in or as a television signal.

20. A camera as claimed in claim 19, wherein the processor is operable to divide the image data corresponding to each of said images so as to be interlaceable.

21. A camera as claimed in claim 19, wherein the output subsystem is operable to output the image data subsets in or as a television signal in standard NTSC, PAL or SECAM format.

22. A method for inserting at least one image in the form of image data into a television signal, comprising:
dividing said image into a set of image data subsets; and
inserting said set into said television signal with each subset corresponding to a respective field of said television signal and with said set preceded or followed in said television signal by a conventional image frame.

23. A method as claimed in claim 22, wherein said image is one of a plurality of images each in the form of image data and the method includes:
dividing the image data corresponding to each of said images into a respective set of image data subsets; and
inserting said sets periodically into said television signal with each subset corresponding to a respective field of said television signal and with each of said sets preceded or followed in said television signal by a conventional image frame.

24. A method as claimed in claim 23, whereby said sets are separated from one another by an equal number of frames.

25. A method of decoding a television signal, the method comprising:
extracting first image data from the odd image fields of the television signal; and
extracting second image data from the even image fields of the television signal;
wherein one of said first image data and second image data comprises a first set of images that are sequentially displayable as a motion video and the other of said first image data and second image data comprises a second set of images that are assemblable into a further image.

26. A method as claimed in claim 25, wherein said second set of images are assemblable into a plurality of further images.

27. A method as claimed in claim 26, wherein said plurality of further images are sequentially displayable as a further motion video.

28. A method as claimed in claim 27, wherein said further motion video comprises a manipulated version of said motion video derived from said first set of images.

29. A method for processing an image for storage or transmission, comprising:
dividing an image in the form of image data into a plurality of image data subsets; and
sequentially outputting said image data subsets as fields in or as a television signal;
wherein said subsets are both reassemblable by interlacing according to a conventional television standard to form a first image, and otherwise reassemblable to form a second image.
